(19) United States
(12) Patent Application Publication
(10) Pub. No.: US 2016/0196662 A1
(43) Pub. Date: Jul. 7, 2016

(54) METHOD AND DEVICE FOR MANUFACTURING VIRTUAL FITTING MODEL IMAGE

(71) Applicant: BEIJING JINGDONG SHANGKE INFORMATION TECHNOLOGY CO., LTD., Haidian District, Beijing (CN)

(72) Inventor: Gang ZHAO, Haidian District, Beijing (CN)

(21) Appl. No.: 14/912,109

(22) PCT Filed: May 9, 2014
(86) PCT No.: PCT/CN2014/077188

§ 371 Date: Feb. 15, 2016

(30) Foreign Application Priority Data
Aug. 16, 2013 (CN) 201310359012.9

(51) Int. Cl. G06T 7/00; G06Q 30/06; G06K 9/46

(52) U.S. Cl. CPC G06T 7/0093; G06K 9/469; G06Q 30/0621; G06T 7/0083; G06T 2207/20132; G06T 2207/30201

(57) ABSTRACT

A virtual fitting model image makes a fitting effect of a virtual fitting model be more similar to a fitting effect of a user. The method includes extracting a head portrait in a reference image; and synthesizing the head portrait in the reference image with a model body region in a virtual fitting model image to thereby obtain a complete portrait. The head portrait of the user is synthesized with the body region of the virtual fitting model to obtain a new virtual fitting model, and when the new virtual fitting model is used to conduct virtual fitting, a facial form, a skin color, etc., are all consistent with those of the user himself/herself, so as compared with a virtual fitting model in an image library, the virtual fitting model having the head portrait of the user has a fitting effect more similar to the fitting effect of the user.

### TECHNICAL FIELD

The invention relates to a method and device for manufacturing a virtual fitting model image.

### BACKGROUND ART

Virtual fitting refers to making a virtual model try on clothes sold on the internet in place of a real user using a computer technique, which forms a reference for a selective purchase of the clothes on the internet by the user by means of an effect presented by fitting by the virtual model, and facilitates a purchase of proper clothes by the user.

The current virtual fitting scheme mainly uses a virtual fitting model in an image library, and the user selects the virtual fitting model and clothes, so that the clothes can be selected by means of an effect of the model wearing the clothes.

### SUMMARY OF THE INVENTION

The invention provides a method and device for manufacturing a virtual fitting model image, which are helpful to make a fitting effect of a virtual fitting model be more similar to a fitting effect of a user himself/herself.

In order to achieve the above object, according to one aspect of the invention, a method for manufacturing a virtual fitting model image is provided.

The method for manufacturing a virtual fitting model image of the invention comprises: extracting a head portrait in a reference image; and synthesizing the head portrait in the reference image with a model body region in a virtual fitting model image to thereby obtain a complete portrait.

Optionally, the step of extracting a head portrait in a reference image comprises: detecting the head portrait in the reference image to determine a diameter of the head portrait and a central position of the head portrait; providing two circles by taking the central position of the head portrait as a center, the first circle having its diameter close to the diameter of the head portrait, and the second circle having its diameter close to 1.5 times of the diameter of the head portrait; using a GrabCut algorithm to determine a range of the head portrait in the reference image, wherein an interior of the first circle is set to a foreground, a position between the first circle and the second circle is set to a possible foreground, and an exterior of the second circle is set to a background; and extracting an image of the range of the head portrait from the reference image as the head portrait in the reference image.

Optionally, the step of extracting a head portrait in a reference image comprises: detecting the head portrait in the reference image to determine a diameter of the head portrait and a central position of the head portrait; providing two circles by taking the central position of the head portrait as a center of a circle, the first circle having its diameter close to the diameter of the head portrait, and the second circle having its diameter close to 1.5 times of the diameter of the head portrait; using a GrabCut algorithm to obtain a range of the head portrait in the reference image, wherein an interior of the first circle is set to a foreground, a position between the first circle and the second circle is set to a possible foreground, and an exterior of the second circle is set to a background; receiving an instruction for adjusting the range of the head portrait and adjusting the range of the head portrait in accordance with the instruction; using the GrabCut algorithm to determine an accurate range of the head portrait in the adjusted range of the head portrait, wherein an interior of an edge curve of the adjusted range of the head portrait is set to the foreground, and an exterior thereof is set to the background; and extracting an image of the accurate range of the head portrait from the reference image as the head portrait in the reference image.

Optionally, after the step of using a GrabCut algorithm to obtain a range of the head portrait in the reference image, and before the step of receiving an instruction for adjusting the range of the head portrait, the method further comprises: providing a plurality of control points on an edge of the range of the head portrait in the reference image; the instruction is used for adjusting the position of the control point; and the step of adjusting the range of the head portrait in accordance with the instruction comprises: adjusting the position of the control point in accordance with the instruction and determining the adjusted range of the head portrait in accordance with the adjusted position of the control point.

Optionally, the step of synthesizing the head portrait in the reference image with a model body region in a virtual fitting model image comprises: determining a central axis of the head portrait in the reference image; and splicing the head portrait in the reference image with the model body region in the virtual fitting model image, and making the central axis and a central axis of the model body region be on the same straight line.

According to the other aspect of the invention, a device for manufacturing a virtual fitting model image is provided.

The device for manufacturing a virtual fitting model image of the invention comprises: an extracting module for extracting a head portrait in a reference image; and a synthesizing module for synthesizing the head portrait in the reference image with a model body region in a virtual fitting model image to thereby obtain a complete portrait.

Optionally, the extracting module is further used for: detecting the head portrait in the reference image to determine a diameter of the head portrait and a central position of the head portrait; providing two circles by taking the central position of the head portrait as a center, the first circle having its diameter close to the diameter of the head portrait, and the second circle having its diameter close to 1.5 times of the diameter of the head portrait; using a GrabCut algorithm to determine a range of the head portrait in the reference image, wherein an interior of the first circle is set to a foreground, a position between the first circle and the second circle is set to a possible foreground, and an exterior of the second circle is set to a background; and extracting an image of the range of the head portrait from the reference image as the head portrait in the reference image.

Optionally, the extracting module is further used for: detecting the head portrait in the reference image to determine a diameter of the head portrait and a central position of the head portrait; providing two circles by taking the central position of the head portrait as a center of a circle, the first circle having its diameter close to the diameter of the head portrait, and the second circle having its diameter close to 1.5 times of the diameter of the head portrait; using a GrabCut algorithm to obtain a range of the head portrait in the reference image, wherein an interior of the first circle is set to a foreground, a position between the first circle and the second circle is set to a possible foreground, and an exterior of the second circle is set to a background; receiving an instruction for adjusting the range of the head portrait and adjusting the range of the head portrait in accordance with the instruction; using the GrabCut algorithm to determine an accurate range of the head portrait in the adjusted range of the head portrait, wherein an interior of an edge curve of the adjusted range of the head portrait is set to the foreground, and an exterior thereof is set to the background; and extracting an image of the accurate range of the head portrait from the reference image as the head portrait in the reference image.

Optionally, the extracting module is further used for: providing a plurality of control points on an edge of the range of the head portrait in the reference image; and adjusting the position of the control point in accordance with the instruction and determining the adjusted range of the head portrait in accordance with the adjusted position of the control point.

Optionally, the synthesizing module is further used for: determining a central axis of the head portrait in the reference image; and splicing the head portrait in the reference image with the model body region in the virtual fitting model image, and making the central axis and a central axis of the model body region be on the same straight line.

According to the technical solution of the invention, the head portrait of the user is synthesized with the body region of the virtual fitting model to obtain a new virtual fitting model, and when the new virtual fitting model is used to conduct virtual fitting, a facial form, a skin color, etc., are all consistent with those of the user himself/herself, so as compared with a virtual fitting model in an image library, the virtual fitting model having the head portrait of the user has a fitting effect more similar to the fitting effect of the user himself/herself. In addition, in the embodiment of the invention, the application of the GrabCut algorithm to the step of extracting the head portrait is helpful to obtain the head portrait of the user as accurate as possible; and a synthesizing effect is taken into consideration when the head portrait of the user is synthesized with the body region of the virtual fitting model, so that the obtained new virtual fitting model has a better visual effect.

### BRIEF DESCRIPTION OF THE DRAWINGS

Figures are used for better understanding the invention, and do not form improper limitations of the invention. Wherein:

FIG. 1 is a schematic diagram of a preferred flow of extracting a head portrait in a reference image according to an embodiment of the invention;

FIG. 2 is an image where a head portrait of a user is centered according to an embodiment of the invention;

FIG. 3 is a schematic diagram of providing circles in the image containing the head portrait of the user according to an embodiment of the invention;

FIG. 4 is a schematic diagram of using a GrabCut algorithm to obtain a range of the head portrait in the reference image according to an embodiment of the invention;

FIG. 5 is a schematic diagram of the range of the head portrait adjusted by the user according to an embodiment of the invention;

FIG. 6 is a schematic diagram of an accurate range of the head portrait according to an embodiment of the invention;

FIG. 7 is a schematic diagram of an image where the accurate range of the head portrait is extracted according to an embodiment of the invention;

FIG. 8 is a schematic diagram of a synthesized virtual fitting model according to an embodiment of the invention; and

FIG. 9 is a schematic diagram of a basic structure of a device for manufacturing a virtual fitting model image according to an embodiment of the invention.

### DETAILED DESCRIPTION

The contents below give descriptions of exemplary embodiments of the invention by taking the figures into consideration, and the contents include various details of the embodiments of the invention to facilitate understanding, and shall be considered as exemplary ones only. Thus, those skilled in the art should realize that the embodiments described herein can be changed and modified in various manners without departing from the scope and spirit of the invention. Similarly, for clarity and conciseness, descriptions of common functions and structures are omitted in the descriptions below.

In an embodiment of the invention, a user provides a reference image for a server in an electronic commerce system through a terminal device such as a personal computer, the reference image has a head portrait of the user, which is generally a front picture of the user, the server obtains a virtual fitting model having the head portrait of the user in accordance with the reference image and a virtual fitting model image in an image library, and in this processing, the server firstly extracts the head portrait in the reference image, and then synthesizes the head portrait in the reference image with a model body region in the virtual fitting model image to thereby obtain a complete portrait. Since the complete portrait has the head portrait of the user, when it serves as the virtual fitting model, a facial form, a skin color, etc., are all consistent with those of the user himself/herself, so as compared with the virtual fitting model in the image library, the virtual fitting model having the head portrait of the user has a fitting effect more similar to the fitting effect of the user himself/herself.

In order to make the virtual fitting model having the head portrait of the user have a better visual effect, in a solution in the embodiment, a relevant measure is adopted to make the accuracy of the extraction of the head portrait higher and improve an effect when the head portrait of the user is synthesized with the body of the virtual fitting model. Explanations of a specific technical solution of the embodiment are given below.

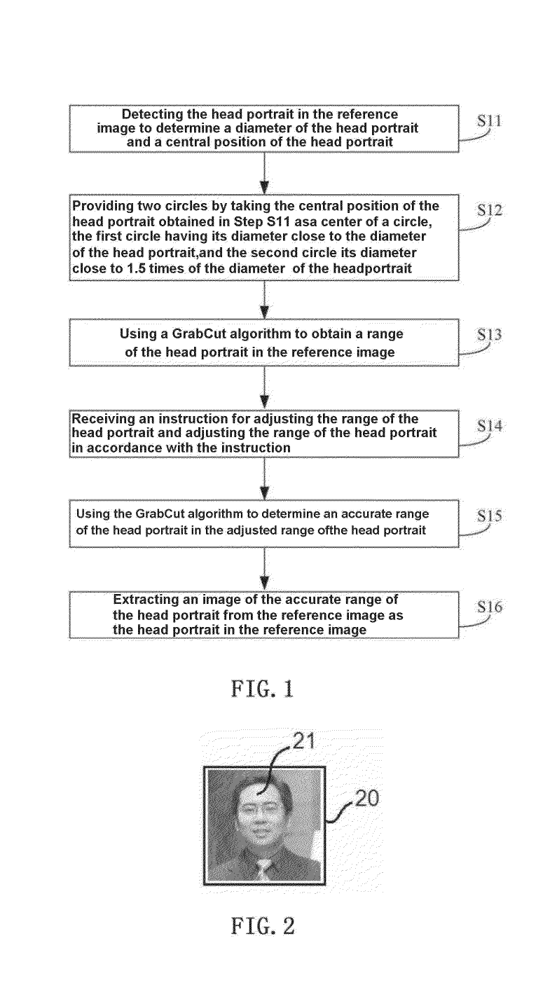

FIG. 1 is a schematic diagram of a preferred flow of extracting a head portrait in a reference image according to an embodiment of the invention. As shown in FIG. 1, the following steps can be followed when the server extracts the head portrait from the reference image provided by the user:

Step S11: Detecting the head portrait in the reference image to determine a diameter of the head portrait and a central position of the head portrait. The step can be achieved by adopting the current human face detection (or called face recognition, human face recognition, portrait recognition, etc.) technology. The central position of the head portrait is generally a nose tip position of the portrait, or can be a center of figure of a human face region. After the diameter of the head portrait and the central position of the head portrait are determined, the head portrait region is also determined therewith. In this case, the reference image can be properly cut to make the head portrait be centered, as shown in FIG. 2. FIG. 2 is an image where a head portrait of a user is centered according to an embodiment of the invention, where a head portrait 21 of the user is made to be located in a centered position in an image 20.

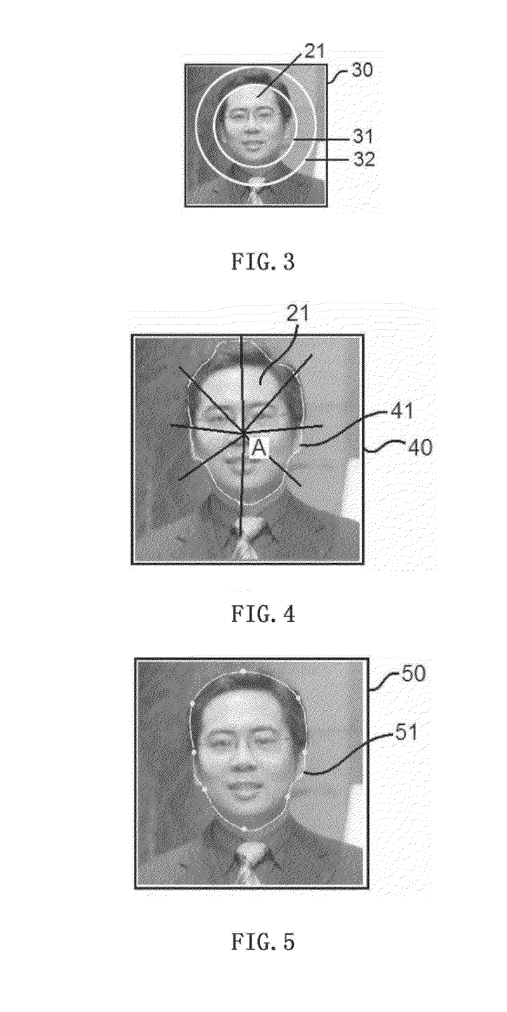

Step S12: Providing two circles by taking the central position of the head portrait obtained in Step S11 as a center of a circle, the first circle having its diameter close to the diameter of the head portrait, and the second circle having its diameter close to 1.5 times of the diameter of the head portrait. The two circles are used to provide parameters for a GrabCut algorithm in Step S13, and the diameter can be properly adjusted according to actual requirements. FIG. 3 can be referred to. FIG. 3 is a schematic diagram of providing circles in the image containing the head portrait of the user according to an embodiment of the invention, where in an image 30, a circle 31 and a circle 32 are provided on the head portrait 21 of the user, the circle 31 having its diameter close to the diameter of the portrait 21, and the circle 32 having its diameter close to 1.5 times of the diameter of the head portrait 21.

Step S13: Using a GrabCut algorithm to obtain a range of the head portrait in the reference image. When the GrabCut algorithm is applied, an interior of the circle 31 is set to a foreground, a position between the circle 31 and the circle 32 is set to a possible foreground, and an exterior of the circle 32 is set to a background. FIG. 4 can be referred to for an edge of the range of the head portrait obtained after the completion of the algorithm. FIG. 4 is a schematic diagram of using a GrabCut algorithm to obtain a range of the head portrait in the reference image according to an embodiment of the invention. As shown in FIG. 4, in an image 40, a curve 41 is an edge of the head portrait 21 of the user.

Step S14: Receiving an instruction for adjusting the range of the head portrait and adjusting the range of the head portrait in accordance with the instruction. The instruction is given by the user by operating a terminal device. Since the operation is performed by the user, the user can make some acceptances and rejections of the head portrait of the user himself/herself, e.g., properly selecting the length of the neck connected to the head. The server can provide some control points on the edge of the range of the head portrait for usage by the user, and the user can adjust the shape of the edge on both sides of the control points only by dragging the control points with a mouse. Referring to FIG. 4, the control points had better be provided to be convenient for an adjustment of various parts on the edge of the head portrait by the user, so several, e.g., eight, rays can be firstly made from a point A that is a position close to the center within the range of the head portrait, included angles between adjacent rays are close or equal, and an intersection point of the ray and the edge of the head portrait 21 of the user, i.e., the curve 41, is just the control point. FIG. 5 can be referred to for a state after the user adjusts the range of the head portrait. FIG. 5 is a schematic diagram of the range of the head portrait adjusted by the user according to an embodiment of the invention, where in an image 50, the edge of the range of the head portrait adjusted by the user is a curve 51.

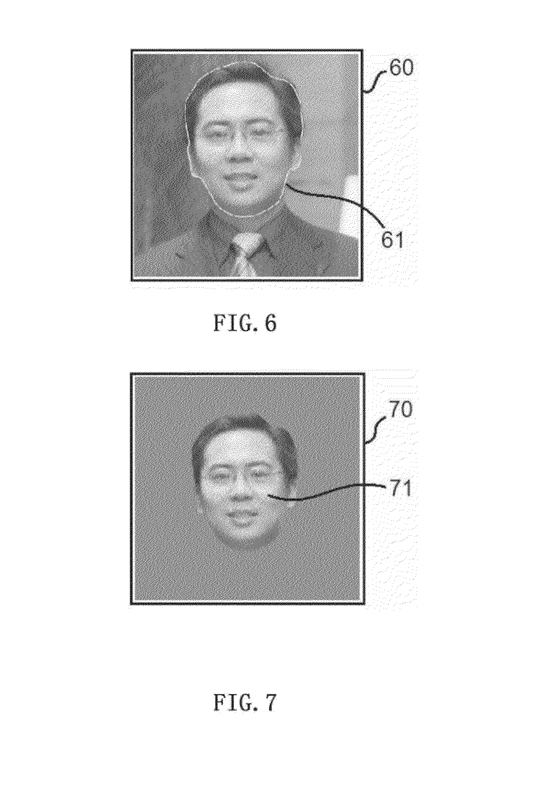

Step S15: Using the GrabCut algorithm to determine an accurate range of the head portrait in the adjusted range of the head portrait. The computation this time is to make the range of the head portrait be more accurate. When the parameters of the GrabCut algorithm are set, an interior of the edge curve 51 of the adjusted range of the head portrait is set to the foreground, and an exterior of the curve 51 is set to the background. The accurate range of the head portrait obtained after the computation is as shown in FIG. 6. FIG. 6 is a schematic diagram of an accurate range of the head portrait according to an embodiment of the invention, where an edge of the range of the head portrait in an image 60 is a curve 61.

Step S16: Extracting an image of the accurate range of the head portrait from the reference image as the head portrait in the reference image, as shown in FIG. 7. FIG. 7 is a schematic diagram of an image where the accurate range of the head portrait is extracted according to an embodiment of the invention. In FIG. 7, in an image 70, a background outside the accurate range of the head portrait in FIG. 6 is removed based on the accurate range of the head portrait in FIG. 6 to thereby obtain an accurate head portrait 71.

It should be noted that if in the picture provided by the user, a difference in color between the foreground (the head portrait of the user) and the background is comparatively large, a quite accurate head portrait can be obtained in Step S13, in this case, Steps S14 and S15 are not required, and it is allowed to directly extract in Step S16 an image within the range of the head portrait in Step S13.

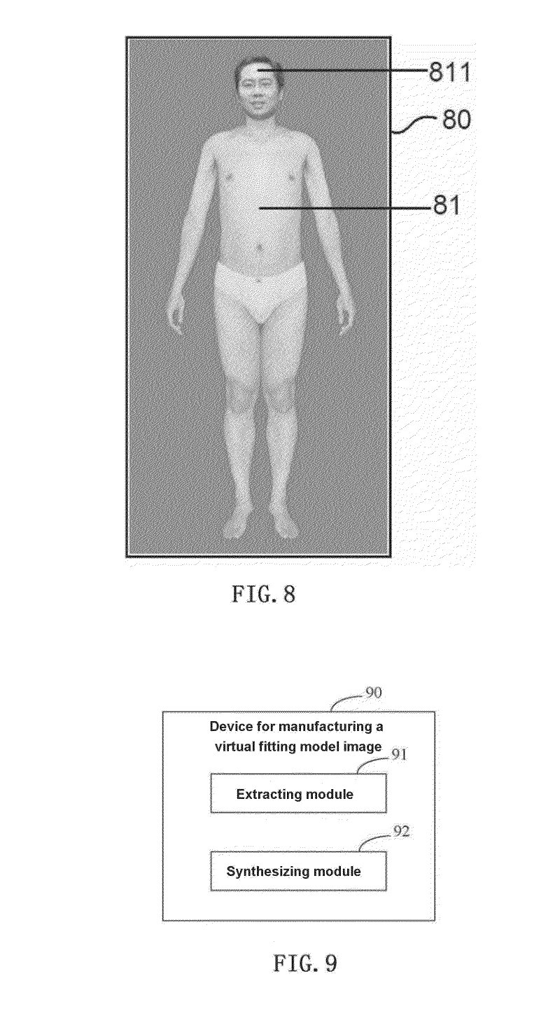

After the head portrait of the user is obtained, it is required to synthesize the head portrait of the user with the model body region in the virtual fitting model image. In order to improve the visual effect of the complete portrait after the synthesis, in the embodiment, the head portrait of the user is aligned with the model body in the virtual fitting model image. The specific procedure is as follows: firstly determining a central axis of the head portrait in the reference image, which central axis can be determined during the human face recognition process in Step S11; then making the central axis and a central axis of the model body region be on the same straight line when splicing the head portrait in the reference image with the model body region in the virtual fitting model image, as shown in FIG. 8. FIG. 8 is a schematic diagram of a synthesized virtual fitting model according to an embodiment of the invention, where there is a fitting model 81 in an image 80, and a head portrait 811 of the fitting model 81 is the head portrait of the user.

FIG. 9 is a schematic diagram of a basic structure of a device for manufacturing a virtual fitting model image according to an embodiment of the invention. As shown in FIG. 9, a device 90 for manufacturing a virtual fitting model image mainly comprises: an extracting module 91 and a synthesizing module 92. The extracting module 91 is used for extracting a head portrait in a reference image; and the synthesizing module 92 for synthesizing the head portrait in the reference image with a model body region in a virtual fitting model image to thereby obtain a complete portrait.

The extracting module 91 can be further used for: detecting the head portrait in the reference image to determine a diameter of the head portrait and a central position of the head portrait; providing two circles by taking the central position of the head portrait as a center, the first circle having its diameter close to the diameter of the head portrait, and the second circle having its diameter close to 1.5 times of the diameter of the head portrait; using a GrabCut algorithm to determine a range of the head portrait in the reference image, wherein an interior of the first circle is set to a foreground, a position between the first circle and the second circle is set to a possible foreground, and an exterior of the second circle is set to a background; and extracting an image of the range of the head portrait from the reference image as the head portrait in the reference image.

The extracting module 91 can be further used for: detecting the head portrait in the reference image to determine a diameter of the head portrait and a central position of the head portrait; providing two circles by taking the central position of the head portrait as a center of a circle, the first circle having its diameter close to the diameter of the head portrait, and the second circle having its diameter close to 1.5 times of the diameter of the head portrait; using a GrabCut algorithm to obtain a range of the head portrait in the reference image, wherein an interior of the first circle is set to a foreground, a position between the first circle and the second circle is set to a possible foreground, and an exterior of the second circle is set to a background; receiving an instruction for adjusting the range of the head portrait and adjusting the range of the head portrait in accordance with the instruction; using the GrabCut algorithm to determine an accurate range of the head portrait in the adjusted range of the head portrait, wherein an interior of an edge curve of the adjusted range of the head portrait is set to the foreground, and an exterior thereof is set to the background; and extracting an image of the accurate range of the head portrait from the reference image as the head portrait in the reference image.

The extracting module 91 can be further used for: providing a plurality of control points on an edge of the range of the head portrait in the reference image; and adjusting the position of the control point in accordance with the instruction and determining the adjusted range of the head portrait in accordance with the adjusted position of the control point.

The synthesizing module 92 can be further used for: determining a central axis of the head portrait in the reference image; and splicing the head portrait in the reference image with the model body region in the virtual fitting model image, and making the central axis and a central axis of the model body region be on the same straight line.

According to the technical solution of the embodiment of the invention, the head portrait of the user is synthesized with the body region of the virtual fitting model to obtain a new virtual fitting model, and when the new virtual fitting model is used to conduct virtual fitting, a facial form, a skin color, etc., are all consistent with those of the user himself/herself, so as compared with a virtual fitting model in an image library, the virtual fitting model having the head portrait of the user has a fitting effect more similar to the fitting effect of the user himself/herself. In addition, in the embodiment of the invention, the application of the GrabCut algorithm to the step of extracting the head portrait is helpful to obtain the head portrait of the user as accurate as possible; and a synthesizing effect is taken into consideration when the head portrait of the user is synthesized with the body region of the virtual fitting model, so that the obtained new virtual fitting model has a better visual effect.

The contents above describe the basic principle of the invention by taking the embodiments into consideration, but it should be noted that those skilled in the art can understand that all of or any of steps or components of the method and device of the invention can be achieved by hardware, firmware, software or a combination thereof in any computing apparatus (including a processor, a storage medium, etc.) or a network of a computing apparatus. This can be achieved by those skilled in the art just by using their basic programming skills in the case of reading the descriptions of the invention.

Thus, the object of the invention can be further achieved by running a program or a group of programs on any computing apparatus. The computing apparatus can be a common universal apparatus. Thus, the object of the invention can be also achieved only by providing a program product containing a program code for achieving the method or device. That is to say, such program product also forms the invention, and a storage medium storing such program product also forms the invention. Obviously, the storage medium can be any common storage medium or any storage medium to be developed in the future.

It should be further noted that in the device and method of the invention, it is obvious that the respective components or respective steps can be separated and/or recombined. These separations and/or recombinations shall be deemed as equivalent solutions of the invention. Furthermore, the steps for performing the above-mentioned series of processings can be naturally chronologically performed in the described order, but are not necessarily chronologically performed. Some steps can be performed in parallel or independently of each other.

The above embodiments do not form limitations of the scope of protection of the invention. Those skilled in the art should understand that depending on requirements for design and other factors, various modifications, combinations, sub-combinations and substitutions can occur. Any modification, equivalent substitution, improvement and the like made within the spirit and principle of the invention shall be contained in the scope of protection of the invention.

1-10. (canceled)

11. A method for manufacturing a virtual fitting model image, characterized by comprising:
extracting a head portrait in a reference image; and
synthesizing the head portrait in the reference image with a model body region in a virtual fitting model image to thereby obtain a complete portrait.

12. The method according to claim 11, characterized in that the step of extracting a head portrait in a reference image comprises:
detecting the head portrait in the reference image to determine a diameter of the head portrait and a central position of the head portrait;
providing two circles by taking the central position of the head portrait as a center, the first circle having its diameter close to the diameter of the head portrait, and the second circle having its diameter close to 1.5 times of the diameter of the head portrait;
using a GrabCut algorithm to determine a range of the head portrait in the reference image, wherein an interior of the first circle is set to a foreground, a position between the first circle and the second circle is set to a possible foreground, and an exterior of the second circle is set to a background; and
extracting an image of the range of the head portrait from the reference image as the head portrait in the reference image.

13. The method according to claim 11, characterized in that the step of extracting a head portrait in a reference image comprises:
detecting the head portrait in the reference image to determine a diameter of the head portrait and a central position of the head portrait;
providing two circles by taking the central position of the head portrait as a center of a circle, the first circle having its diameter close to the diameter of the head portrait, and the second circle having its diameter close to 1.5 times of the diameter of the head portrait;
using a GrabCut algorithm to obtain a range of the head portrait in the reference image, wherein an interior of the first circle is set to a foreground, a position between the first circle and the second circle is set to a possible foreground, and an exterior of the second circle is set to a background;
receiving an instruction for adjusting the range of the head portrait and adjusting the range of the head portrait in accordance with the instruction;
using the GrabCut algorithm to determine an accurate range of the head portrait in the adjusted range of the head portrait, wherein an interior of an edge curve of the adjusted range of the head portrait is set to the foreground, and an exterior thereof is set to the background; and
extracting an image of the accurate range of the head portrait from the reference image as the head portrait in the reference image.

14. The method according to claim 13, characterized in that after the step of using a GrabCut algorithm to obtain a range of the head portrait in the reference image, and before the step of receiving an instruction for adjusting the range of the head portrait, the method further comprises:
providing a plurality of control points on an edge of the range of the head portrait in the reference image;
the instruction is used for adjusting the position of the control point; and
the step of adjusting the range of the head portrait in accordance with the instruction comprises:
adjusting the position of the control point in accordance with the instruction and
determining the adjusted range of the head portrait in accordance with the adjusted position of the control point.

15. The method according to claim 14, characterized in that the step of synthesizing the head portrait in the reference image with a model body region in a virtual fitting model image comprises:
determining a central axis of the head portrait in the reference image; and
splicing the head portrait in the reference image with the model body region in the virtual fitting model image, and making the central axis and a central axis of the model body region be on the same straight line.

16. The method according to claim 13, characterized in that the step of synthesizing the head portrait in the reference image with a model body region in a virtual fitting model image comprises:
determining a central axis of the head portrait in the reference image; and
splicing the head portrait in the reference image with the model body region in the virtual fitting model image, and making the central axis and a central axis of the model body region be on the same straight line.

17. The method according to claim 12, characterized in that the step of synthesizing the head portrait in the reference image with a model body region in a virtual fitting model image comprises:
determining a central axis of the head portrait in the reference image; and
splicing the head portrait in the reference image with the model body region in the virtual fitting model image, and making the central axis and a central axis of the model body region be on the same straight line.

18. The method according to claim 11, characterized in that the step of synthesizing the head portrait in the reference image with a model body region in a virtual fitting model image comprises:
determining a central axis of the head portrait in the reference image; and
splicing the head portrait in the reference image with the model body region in the virtual fitting model image, and making the central axis and a central axis of the model body region be on the same straight line.

19. A device for manufacturing a virtual fitting model image, characterized by comprising:
an extracting module for extracting a head portrait in a reference image; and
a synthesizing module for synthesizing the head portrait in the reference image with a model body region in a virtual fitting model image to thereby obtain a complete portrait.

20. The device according to claim 19, characterized in that the extracting module is further used for:
detecting the head portrait in the reference image to determine a diameter of the head portrait and a central position of the head portrait;
providing two circles by taking the central position of the head portrait as a center, the first circle having its diameter close to the diameter of the head portrait, and the second circle having its diameter close to 1.5 times of the diameter of the head portrait;
using a GrabCut algorithm to determine a range of the head portrait in the reference image, wherein an interior of the first circle is set to a foreground, a position between the first circle and the second circle is set to a possible foreground, and an exterior of the second circle is set to a background; and
extracting an image of the range of the head portrait from the reference image as the head portrait in the reference image.

21. The device according to claim 19, characterized in that the extracting module is further used for:
detecting the head portrait in the reference image to determine a diameter of the head portrait and a central position of the head portrait;
providing two circles by taking the central position of the head portrait as a center of a circle, the first circle having its diameter close to the diameter of the head portrait, and the second circle having its diameter close to 1.5 times of the diameter of the head portrait;
using a GrabCut algorithm to obtain a range of the head portrait in the reference image, wherein an interior of the first circle is set to a foreground, a position between the first circle and the second circle is set to a possible foreground, and an exterior of the second circle is set to a background;
receiving an instruction for adjusting the range of the head portrait and adjusting the range of the head portrait in accordance with the instruction;
using the GrabCut algorithm to determine an accurate range of the head portrait in the adjusted range of the head portrait, wherein an interior of an edge curve of the adjusted range of the head portrait is set to the foreground, and an exterior thereof is set to the background; and
extracting an image of the accurate range of the head portrait from the reference image as the head portrait in the reference image.

22. The device according to claim 21, characterized in that the extracting module is further used for:
providing a plurality of control points on an edge of the range of the head portrait in the reference image; and
adjusting the position of the control point in accordance with the instruction and determining the adjusted range of the head portrait in accordance with the adjusted position of the control point.

23. The device according to claim 22, characterized in that the synthesizing module is further used for:
determining a central axis of the head portrait in the reference image; and
splicing the head portrait in the reference image with the model body region in the virtual fitting model image, and making the central axis and a central axis of the model body region be on the same straight line.

24. The device according to claim 21, characterized in that the synthesizing module is further used for:
determining a central axis of the head portrait in the reference image; and
splicing the head portrait in the reference image with the model body region in the virtual fitting model image, and making the central axis and a central axis of the model body region be on the same straight line.

25. The device according to claim 20, characterized in that the synthesizing module is further used for:
determining a central axis of the head portrait in the reference image; and
splicing the head portrait in the reference image with the model body region in the virtual fitting model image, and making the central axis and a central axis of the model body region be on the same straight line.

26. The device according to claim 19, characterized in that the synthesizing module is further used for:
determining a central axis of the head portrait in the reference image; and
splicing the head portrait in the reference image with the model body region in the virtual fitting model image, and making the central axis and a central axis of the model body region be on the same straight line.
